(19) United States
(12) Patent Application Publication
(10) Pub. No.: US 2025/0138732 A1
(43) Pub. Date: May 1, 2025

(54) HARDWARE TRACKING OF MEMORY ACCESSES

(71) Applicant: Rambus Inc., San Jose, CA (US)

(72) Inventor: J. James Tringali, Los Altos, CA (US)

(21) Appl. No.: 18/922,774

(22) Filed: Oct. 22, 2024

Related U.S. Application Data
(60) Provisional application No. 63/546,896, filed on Nov. 1, 2023.

(51) Int. Cl. G06F 3/06

(52) U.S. Cl. CPC G06F 3/0613; G06F 3/0659; G06F 3/0673

(57) ABSTRACT

Technologies for hardware-based memory access telemetry tracking are described. A receiver circuit includes analog and digital circuitry. A memory controller includes a processing pipeline with a first processing stage to update and record a first number of access counts targeting a logical grouping of memory locations and a second processing stage to continuously sort the first number of access counts and their associated address tags corresponding to the logical grouping of memory locations, keeping only the access counts with unique address tags.

### RELATED APPLICATIONS

This application claims the benefit of U.S. Provisional Application No. 63/546,896, filed Nov. 1, 2023, the entire contents of which is incorporated herein by reference.

### BACKGROUND

Modern computer systems generally include a data storage device, such as a memory component or device. The memory component may be, for example, a random-access memory (RAM) or a dynamic random-access memory (DRAM) device. The memory device includes memory banks made up of memory cells that a memory controller or memory client accesses through a command interface and a data interface within the memory device.

The demand for memory pools in data centers is increasing. To extend the pool of addressable memory beyond what may fit in Dual In-Line Memory Module (DIMM) sockets attached to a central processing unit (CPU) socket, vendors have enabled memory traffic over serial links (e.g., OpenCAPI, OMI, NVLink, and CXL). However, adding serialization protocols and interface bridges introduces greater degrees of non-uniformity in memory access.

Conventional methods for managing non-uniform memory access use a combination of classification (i.e., memory tiers) and heuristics for optimizing memory allocation and placement for application performance. Many of these heuristics rely on memory access telemetry on a page granularity to calculate optimal memory placement solutions. Conventional methods use software for tracking memory access telemetry. However, as systems get faster and non-uniformity memory access increases, the latency involved in gathering memory access telemetry using software methods is too high to make timely data placement adjustments to maintain optimum performance. For example, these software techniques require kernel data structure access involving system calls, leading to higher overhead and slow convergence.

### BRIEF DESCRIPTION OF THE DRAWINGS

The present disclosure is illustrated by way of example, and not by way of limitation, in the figures of the accompanying drawings.

FIG. 1 is a block diagram of an integrated circuit with a memory controller and access tracking logic according to at least one embodiment.

FIG. 2 is a high-level block diagram of a memory controller with access tracking logic according to at least one embodiment.

FIG. 3A illustrates a counting Bloom filter (CBF) according to at least one embodiment.

FIG. 3B illustrate a CBF according to at least one embodiment.

FIG. 4 is a graph illustrating a tradeoff between a number of hashes, an array size, and a false positivity rate according to at least one embodiment.

FIG. 5 is a block diagram of access tracking logic according to at least one embodiment.

FIG. 6 is a block diagram of sorting atom structure according to at least one embodiment.

FIG. 7 is a flow diagram of a method of operating a sorting atom structure of FIG. 8 according to at least one embodiment.

FIG. 8 illustrates a uniquify example where the tuple sorting pipeline keeps only tuples with unique address tags according to at least one embodiment.

FIG. 9 is a flow diagram of a method for sorting multiple copies of access counts targeting different logical groupings of memory locations according to at least one embodiment.

FIG. 10 illustrates an output array over time in a register file according to at least one embodiment.

### DETAILED DESCRIPTION

Technologies for hardware-based memory access telemetry tracking are described. In general, DRAM memory represents a significant portion of the operating costs for data center scale computers. Significant improvement in operational efficiency may be enjoyed when the granularity of computation (i.e., grain of computation) is decoupled from the granularity of memory (i.e., grain of memory). However, creating large memory surfaces using hierarchical connection schemes increases levels of memory access non-uniformity. So, by taking advantage of access frequency telemetry at a page granularity, memory placement may be adjusted for optimum performance while maintaining cost efficiency.

As described above, conventional methods use software for tracking memory access telemetry. However, as systems get faster and non-uniformity memory access increases, the latency involved in gathering memory access telemetry using software methods is too high to make timely data placement adjustments to maintain optimum performance. For example, these software techniques require kernel data structure access involving system calls, leading to higher overhead and slow convergence.

Aspects and embodiments of the present disclosure address the above and other deficiencies by providing a hardware solution for tracking access frequency telemetry at a specified granularity (e.g., operating system page granularity) with higher accuracy, lower overhead, and lower costs than conventional solutions. A “page” refers to a fixed-size block of memory that an operating system and hardware use for memory management or virtual memory systems. In the context of memory management and virtual memory systems, a “page tag” may be a piece of metadata associated with a page of memory. In virtual memory systems, memory is divided into fixed-size blocks called “pages.” Each page in memory may correspond to a page of data in secondary storage (usually a hard disk or SSD). The page tag could be a small piece of information stored alongside each page of memory, indicating various attributes about that page, such as whether it is resident in physical memory, its access permissions, its location in secondary storage, etc.

Aspects and embodiments of the present disclosure may generate accurate and timely page access frequency telemetry (also referred to as page access heat telemetry). In some embodiments, various hardware components, such as a Bloom filter front-end, a pipeline, and an output array, may be used for generating accurate and timely access frequency telemetry. A Bloom filter front-end may be used for sparse tracking of page accesses over a configurable time interval (also referred to as reporting interval for sorted arrays). A pipeline, working in conjunction with each Bloom filter update, may sort and filter tuples identifying a page tag and an associated count value. That is, the pipeline may be triggered with each Bloom filter update and may continuously process the Bloom filter access tuples, including sorting by counts while uniquifying (or deduplicating) by page tag. An NxM output array may be used to capture the N-hottest pages (e.g., the N most frequently accessed pages) per time interval over a set of M intervals. The time interval, N, and M are configurable. Aspects and embodiments of the present disclosure may provide command and control interfaces for querying and resetting the various hardware components.

In at least one embodiment, a memory controller contains a processing pipeline that updates and records multiple copies of access counts targeting a logical grouping of memory locations coupled with a processing stage that continuously sorts these access counts and their associated address tags, keeping only entries with unique address tags. In further embodiments, the access counts may be pre-filtered using the Bloom filter or other filtering techniques. The reporting interval for sorted arrays may be configurable. The depth and number of address copies of the front-end access count array may be configurable. The sorted, address-unique output array may be queried anytime. Also, the pipeline may be reset (e.g., restarted) at any point in time.

Advantages of the present disclosure include, but are not limited to, timely delivery of instantaneous assessments of the top N most frequently accessed pages, an ability to capture a time series of the above instantaneous frequency maps, allowing control software (e.g., hypervisor, operating system (OS), real-time OS (RTOS), etc.) to perform trend analysis and gain page access recency insights.

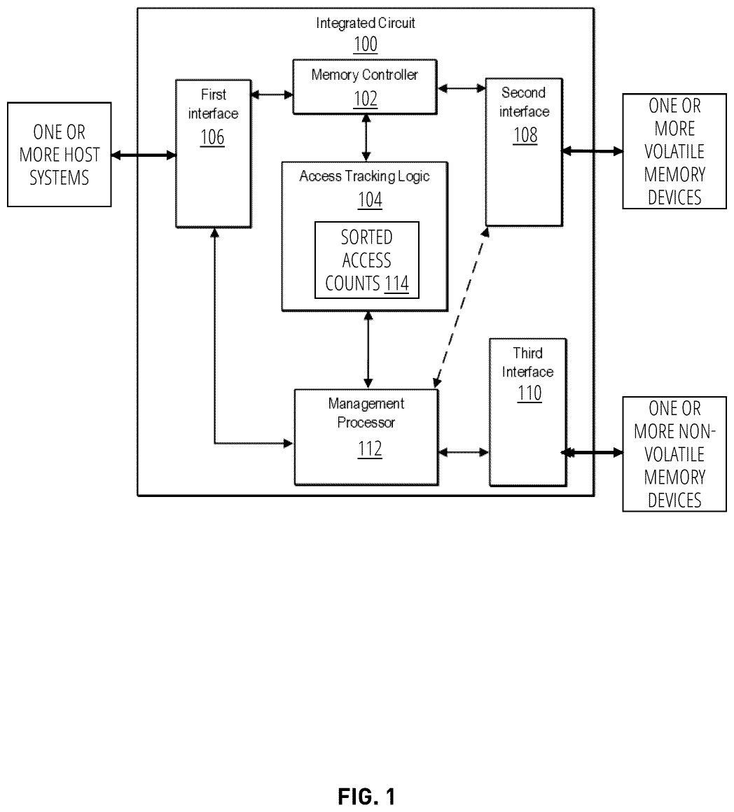

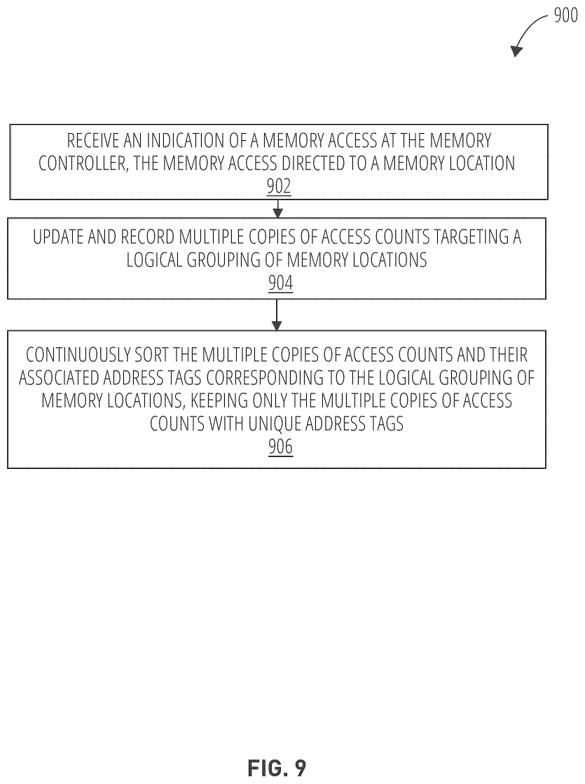

FIG. 1 is a block diagram of an integrated circuit 100 with a memory controller 102 and access tracking logic 104 according to at least one embodiment. In at least one embodiment, the integrated circuit 100 is a controller device that may communicate with one or more host systems (not illustrated in FIG. 1), for example, using a cache-coherent interconnect protocol (e.g., the Compute Express Link (CXL®) protocol). The integrated circuit 100 may be a device that implements the CXL® standard. The CXL® protocol may be built upon physical and electrical interfaces of a PCI Express® standard with protocols that establish coherency, simplify the software stack, and maintain compatibility with existing standards. The integrated circuit 100 includes a first interface 106 coupled to one or more host systems or a fabric manager, a second interface 108 coupled to one or more memory devices (not illustrated in FIG. 9). In other embodiments, the integrated circuit 100 may include a third interface 110 coupled to one or more non-volatile memory devices (not illustrated in FIG. 9). The one or more volatile memory devices may be DRAM devices. The integrated circuit 100 may be part of a single-host memory expansion integrated circuit, a multi-host memory pooling integrated circuit coupled to multiple host systems over multiple cache-coherent interconnects, or the like.

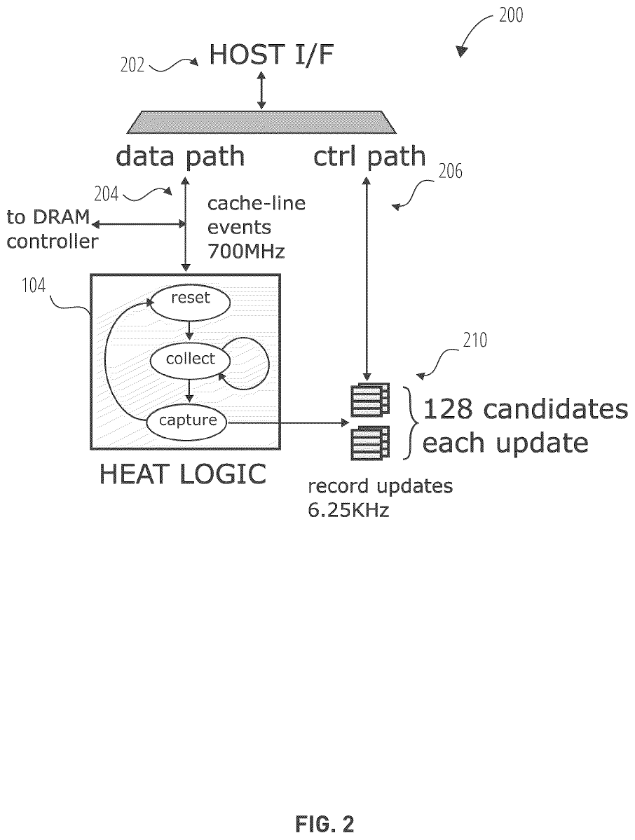

In one embodiment, the memory controller 102 receives data from a host over the first interface 106 or from a volatile memory device over the second interface 108. The memory controller 102 sends data to the host over the first interface 106 or to a volatile memory device over the second interface 108. The access tracking logic 104 is coupled to or part of the memory controller 102. The access tracking logic 104 may receive an indication of a memory access directed to a memory location. The indication may include a memory address or a memory tag that identifies the memory location being accessed. The access tracking logic 104 may update and record multiple copies of access counts targeting a logical grouping of memory locations. The logical grouping of memory locations may be conventional operating system page sizes or other grains of interest. The address tags may be page tags received by the access tracking logic 104. The access tracking logic 104 may continuously sort the multiple copies of access counts and their associated address tags corresponding to the logical grouping of memory locations as sorted access counts 114, keeping only the multiple copies of access counts with unique address tags. The sorted access counts 114 are accessible by software, such as software on one of the hosts. The sorted access counts 114 may be queried at any time. Additional details of the access tracking logic 104 are described below with respect to FIG. 2 to FIG. 10.

In at least one embodiment, the sorted access counts 114 is a set of M number of snapshots of sorted access counts, where M is a positive integer greater than zero, and each snapshot represents a set of sorted access counts in a configurable time interval. M may represent a number of sample interval heat maps recorded per epoch. As a new snapshot is generated, the oldest snapshot in the set of M number of snapshots may be discarded. The set of M number of snapshots may provide historical access counts over multiple time intervals. In at least one embodiment, the sorted access counts 114 may be stored in an output array. The output array may store N number of access counts (e.g., 128) within a sample interval over M number of intervals (e.g., 32), where N is a positive integer greater than zero. M may be referred to as an epoch, so the output array may store the last M epochs (e.g., 32) of N highest accessed logical grouping of memory locations (e.g., N highest accessed pages) within the sample interval. In at least one embodiment, the output array is stored in a register file accessible by software.

In at least one embodiment, the integrated circuit 100 may be a device that supports the CXL® technology, such as a CXL® memory module. The CXL® memory module may include a CXL® controller or a CXL® memory expansion device (e.g., CXL® memory expander System on Chip (SoC)) that is coupled to DRAM devices (e.g., one or more volatile memory devices) and/or persistent storage memory (e.g., one or more NVM devices). The CXL® memory expansion device may include a management processor 112. The CXL® memory expansion device may include an error correction code (ECC) circuit to detect and correct errors in data read from memory or transferred between entities. The CXL® memory expansion device may use the CXL® memory module, such as an in-line memory encryption (IME) circuit, to encrypt the host's unencrypted data before storing it in the DRAM device. The IME circuit may generate a media access control (MAC) that may be used to verify the encrypted data. In another embodiment, the integrated circuit 100 may include an error correction code (ECC) block or circuit that may generate or verify ECC information associated with the data. In another embodiment, one or more non-volatile memory devices are coupled to a second memory controller of the integrated circuit 100. In another embodiment, the integrated circuit 100 is a processor that implements the CXL® standard and includes an encryption circuit (e.g., in-line memory encryption block) and memory controller 102.

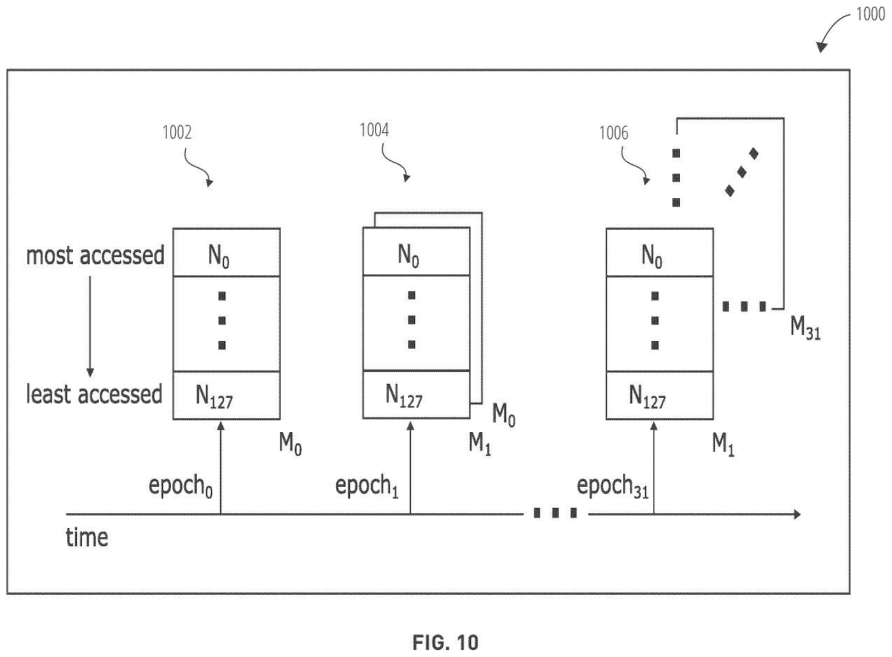

FIG. 2 is a high-level block diagram of a memory controller 200 with access tracking logic 104 according to at least one embodiment. The memory controller 200 may be coupled to a memory device (e.g., DRAM device) via a channel 202. The access tracking logic 104 may monitor the channel 202 for memory accesses on a data path 204. For example, using DDR5-5600 DIMM as the memory target, 700,000 accesses may arrive over one millisecond interval. The memory controller 200 may include a register file 210 to store an output array of access counts corresponding to multiple logical grouping of memory locations (e.g., pages). The memory controller 200 may include a processing pipeline. The processing pipeline may be controlled by a hardware state machine, which includes evaluations, collating and sorting, and updating the output array in the register file 210. In at least one embodiment, the processing pipeline includes a first processing stage and a second processing stage. The first processing stage may update and record a first number (e.g., M=128) of access counts (also referred to herein as multiple copies of access counts) directed to a logical grouping of memory locations. The first processing stage may update and record the first number of access counts over a configurable time interval. As described herein, the local logical grouping of memory locations may be a page. The second processing stage may continuously sort the first number of access counts and their associated address tags corresponding to the logical grouping of memory locations, keeping only the access counts with unique address tags. The output array may store a snapshot of the sorted first number of access counts for a current time interval. The output array may also store multiple previous snapshots, such as up to a number M (e.g., M=32). The register file 210 may be accessible by software via a control path 206 over the channel 202. That is, the register file 210 may be queried by other entities, such as software executed by a host, at any time. An example of the output array over time in a register file is illustrated in FIG. 10.

The access tracking logic 104 (also referred to as “heat logic”) may provide a hardware solution for accurate, low-overhead memory access frequency telemetry (also referred to as “access heat telemetry” or “access telemetry”) that indicates which logical groupings of memory locations are being accessed more frequently than other logical groupings of memory locations. The logical grouping of memory locations may be considered a segment with a corresponding segment identifier (ID). The most accessed segments may be identified as the “hottest” candidates. The memory accesses may be monitored to determine access counts for each logical grouping of memory locations. Those candidates having the highest access counts may be stored in a sorted data structure, such as a list. The sorted data structure may identify a count value and a corresponding identifier (e.g., a page tag corresponding to a page).

In at least one embodiment, the access tracking logic 104 may include multiple configurable parameters for tracking the access telemetry. These parameters may include a tracking unit (TU) size (also referred to as tracking segment granularity) (e.g., 2 MiB), which may be driven by control software (e.g., a hypervisor, an OS, a RTOS, or the like, a number of candidates in an output array (e.g., 128) (also referred to as candidate list length (N) (e.g., 128 TU), an update interval (e.g., <=1 msec), a total node capacity (e.g., 4 TiB), a history requirement, a false positivity accuracy metric (e.g., <=5%), or the like. In at least one embodiment, a customer may configure and reconfigure one or more configurable parameters. In other embodiments, the configurable parameters may be controlled by software.

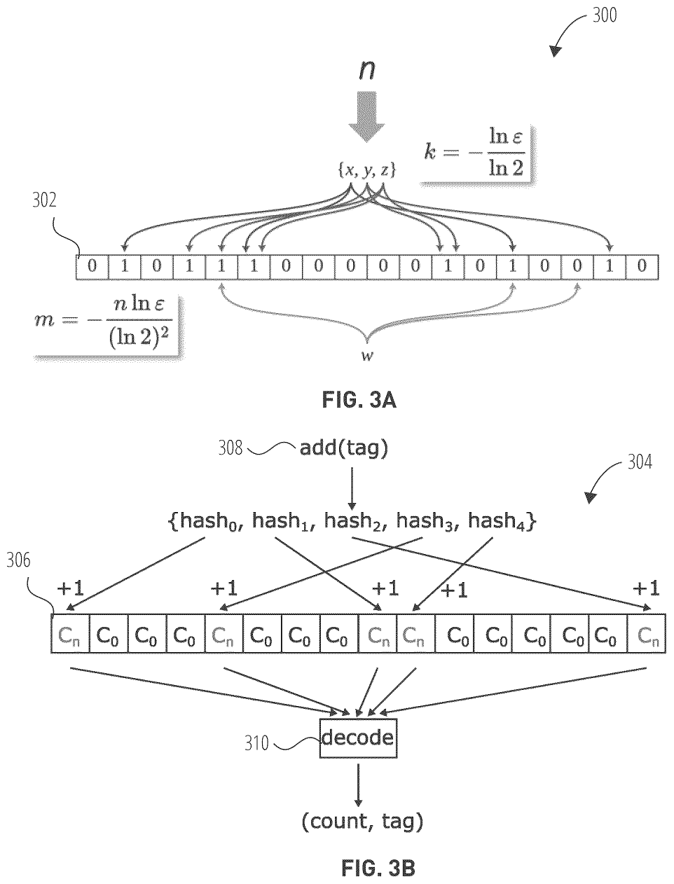

In at least one embodiment, the processing pipeline may include a counting Bloom filter (CBF) and a tuple sorting pipeline, such as described in more detail below with respect to FIG. 3A to FIG. 6. The CBF may be used to reduce a filter interval to a minimum Bloom filter size. On each access capture, the CBF may output an address and count tuple. The output tuples may be input into a deep sorting pipeline. At an end of an interval, a snapshot may be generated and saved into an n-deep register file. The software may access the snapshots in the register file at any given interval. In this regard, instantaneous and windowed views of the tracked data are provided.

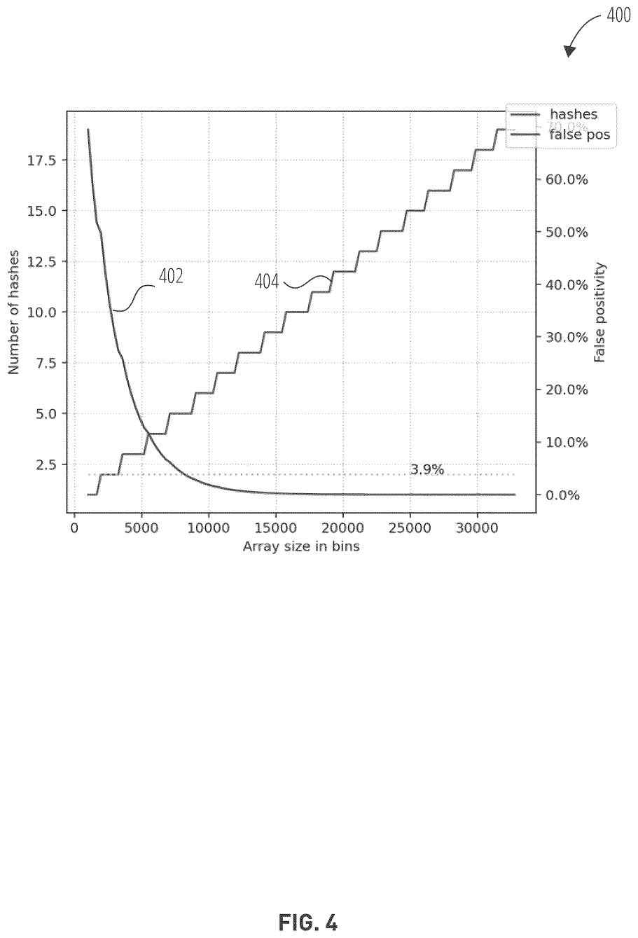

FIG. 3A illustrates a CBF 300 according to at least one embodiment. A Bloom filter is a probabilistic data structure used in computer science to quickly test whether an element is a set member. It efficiently answers membership queries, indicating whether an item is in the set or not. However, unlike traditional data structures like arrays or hash tables, Bloom filters may provide false positives but not false negatives. This means it might sometimes indicate that an element is in the set when it is not, but it will never indicate that an element is not in the set when it actually is. Bloom filters are particularly useful in cases where memory or storage space is limited, and it is desired to check the membership of elements in a set without storing the entire set. A Bloom filter may be initially created as an array of m bits 302, all set to zero. Input keys are input into k-independent hash functions (e.g., hash functions). These hash functions take an input and return an index within the range of the ‘m’ bits in the filter. To insert an element into the CBF 300, each of the k hash functions is applied to an input element and set corresponding bits in the array of m bits 302 to one. To check if an element is in the set, each of the k hash functions is applied to the element and checked if the corresponding in the filter are all set to 1. If all ‘k’ bits are set, the element is possibly in the set (even if there is a chance of a false positive). Since multiple elements could hash to the same bit positions, false positives occur when two or more elements share the same bit positions, and those positions are all set to 1. This is why Bloom filters are considered probabilistic—they may indicate with certainty that an element is not in the set, but they cannot indicate with certainty that an element is in the set (due to potential collisions). As the number of hash functions and the size of the filter are increased, the probability of false positives decreases, but the memory requirements increase, as illustrated in FIG. 4. The CBF 300 may provide a memory-efficient way to test set membership with a small chance of false positives. CBFs are often used when memory is constrained, and the occasional false positive may be tolerated.

As illustrated in FIG. 3A, the input keys are hashed multiple times with unique seeding. There are four examples illustrated in FIG. 3A, where arrows from a set of {x, y, z}show the positions in the array of m bits 302 that each set element is mapped to. The element w in this example is not in the set {x, y, z}because it hashes to one bit-array position containing 0. In this embodiment, m=18 and k=3.

As described above, false positive matches are possible, but false negatives are not. The false positive specification may drive the number of hash functions needed. These hash functions take an input and return an index within the range of the array of m bits 302, which may be selected by the hash function 312. The CBF 300 may be used to determine whether an incoming address tag of a memory access is part of the set and count the number of accesses for the respective address tag. The CBF 300 may provide a tuple with a count value and an associated address tag, as described herein.

FIG. 3B illustrate a CBF 304 according to at least one embodiment. The CBF 304 may initially be created as an array of m elements 306. As illustrated in FIG. 3B, the incoming address tag 308 is hashed multiple times. There are five examples illustrated in FIG. 3B, where arrows from the set of hashes show the positions in the array of m elements 306 that each set element is mapped to. A decoder 310 is coupled to the array and outputs a count and the address tag when the address tag is found in the set.

FIG. 4 is a graph 400 illustrating a tradeoff between a number of hashes, an array size, and a false positivity rate according to at least one embodiment. Graph 400 shows a false positivity rate 402 decreases as an array size in bins increases. As the array size increases, the number of hash functions 404 increases. For example, the false positivity rate 402 may drop below 3.9% for an array size of approximately 9000 bins. For the given number of bins, at least 5 hash functions may be used to achieve 96.1% accuracy. An area under the curve of arrivals versus time drives a filter length. FIG. 4 shows multiple performance improvements over conventional solutions. The maximal use of hardware allows fast selection at a page granularity with 128 top candidates being identified. Based on arrival rates, such as at maximum DDR5-5600 arrival rates, the collection could be completed every 5 microseconds. As described herein, a recency profile (a history requirement) may be easily generated using multiple-interval snapshots. The embodiments described herein may be implemented with a minimal area impact on memory controllers. The page access granularity may be achieved with a modest per port area adder to memory controller designs (e.g., +0.05-0.06%).

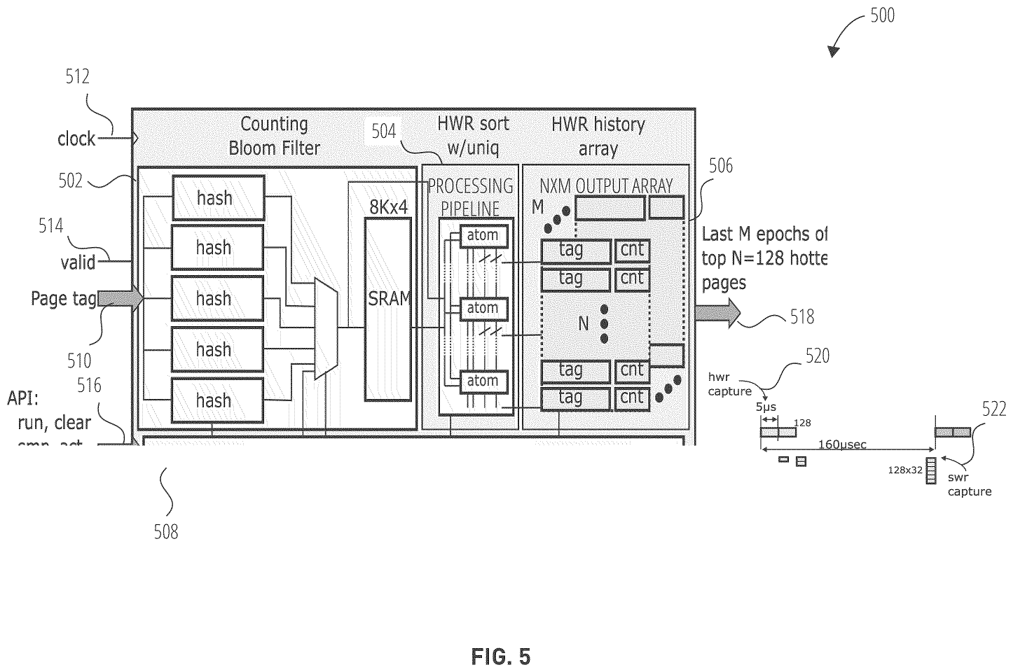

FIG. 5 is a block diagram of access tracking logic 500 according to at least one embodiment. The access tracking logic 500 includes a CBF 502, a processing pipeline 504, a NxM output array 506, and command and control interfaces 508. The access tracking logic 500 may receive a page tag 510, a clock signal 512, a valid signal 514, and command and/or control signals 516. The CBF 502 may be a filter front-end for sparse tracking of page accesses over a configurable time interval. The CBF 502 may receive the page tag 510 and output an access tuple. Each filter update may trigger the processing pipeline 504. The processing pipeline 504 may continuously process the access tuples, sorting by count values while uniquifying by page tag. The uniquifying process, also referred to as a de-duplication process, may discard entries having the same page tag, keeping the entry having the higher counter value. The NxM output array 506 may capture the N-hottest pages per interval over a set of intervals (M). The parameters of N and M are configurable. The command and control interfaces 508 may receive command and/or control signals 516 for querying the NxM output array 506 at any time. The command and control interfaces 508 may receive command and/or control signals 516 for restarting the processing pipeline 504.

In some cases, the CBF 502 alone may not be sufficient to meet either accuracy or performance requirements. The sparse state tracking by the CBF 502 may be leveraged and augmented with the hardware processing pipeline 504 to continuously sort and uniquify on the fly.

In at least one embodiment, at the end of each interval, a snapshot pipeline may be used on the back end to provide recency information. As illustrated in FIG. 5, the access tracking logic 500 may provide output 518 at every time interval, referred to as a hardware capture 520. For example, the NxM output array 506, where M is 32, N is 128, and the time interval is 5 microseconds, may be fully populated after 160 microseconds. After each interval (each epoch), 128 hottest pages may be reported. After 160 microseconds, the last M (32) epochs of the top N (128) pages may be tracked by the access tracking logic 500. At the end of this interval, referred to as a software capture 522, software can access the sorted access counts. Alternatively, the software can query the sorted access counts at any time.

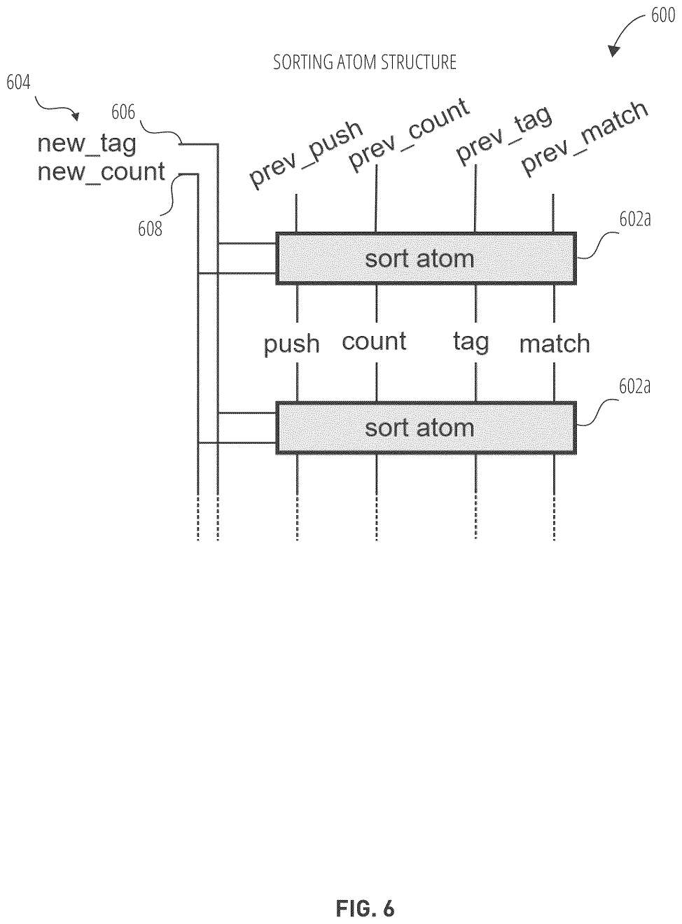

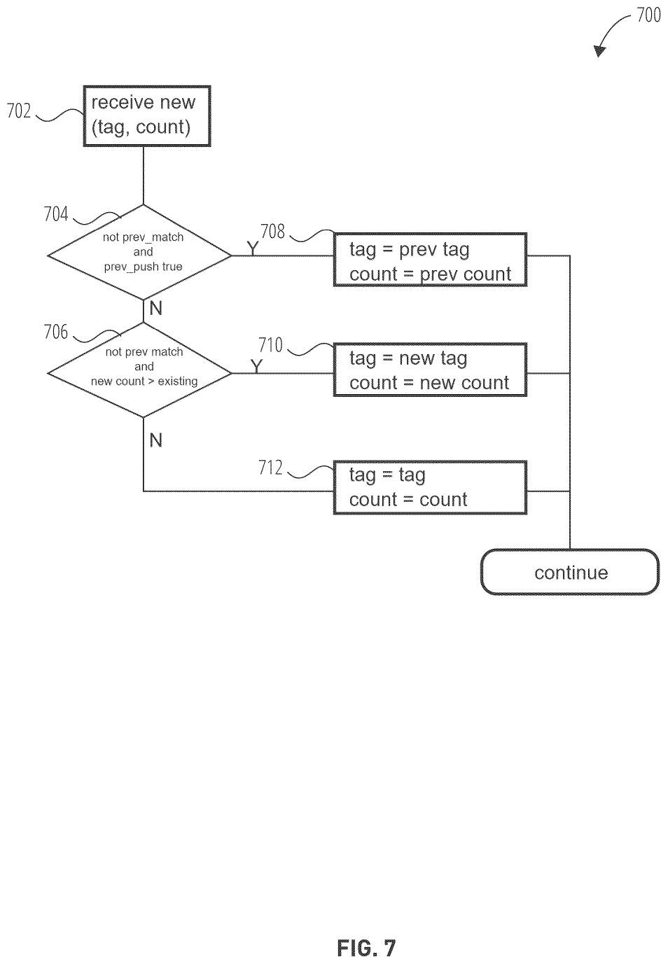

FIG. 6 is a block diagram of sorting atom structure 600 according to at least one embodiment. The sorting atom structure 600 of FIG. 6 shows two sort atoms 602a, 602b (only two shown) in a chain of sort atoms. The sort atoms 602a, 602b each receive a new tuple 604, including a new tag 606 and a new count 608. Each sort atom 602a, 602b may receive indications or signals of a previous push, a previous count, a previous tag, and a previous match, and output indications or signals of a push, a count, a tag, and a match. The operations of the sorting atom structure 600 are described below with respect to FIG. 7.

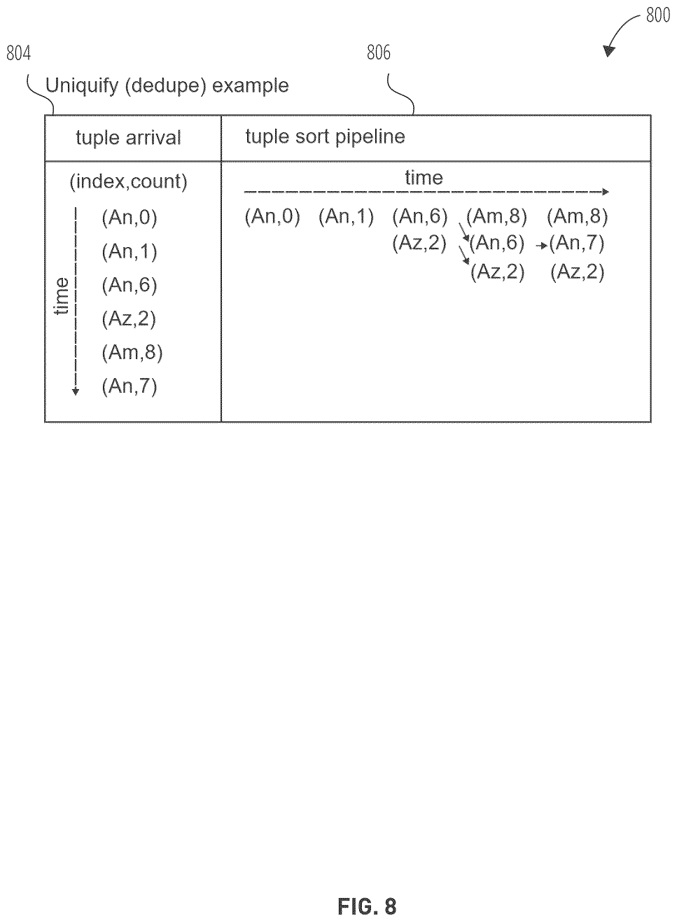

FIG. 7 is a flow diagram of a method 700 of operating a sorting atom structure of FIG. 6 according to at least one embodiment. The method 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 700 is performed by access tracking logic 104, access tracking logic 208, access tracking logic 300, access tracking logic 500, or access tracking logic 600. In at least one embodiment, the sorting logic 304 of FIG. 3, the processing pipeline 504, the sorting atom structure 600 of FIG. 6, the tuple sorting pipeline 806 of FIG. 8 may perform the method 700.

Referring to FIG. 7, the method 700 begins with the processing logic receiving a new tuple (new tag, new count) (block 702). The processing logic determines whether the new tuple meets a first condition (block 704). The first condition may specify that the previous match is not true (not prev_match) and the previous push is true (prev_push true). If the first condition is met at block 704, the processing logic sets a tag to a previous tag and a count to a previous count. If the first condition is not met at block 704, the processing logic determines whether the new tuple meets a second condition (block 706). The second condition may specify that the previous match is not true (not prev_match) and that the new count is greater than an existing count. If the second condition is met at block 706, the processing logic sets an existing tag with the new tag and an existing count with the new count. If the second condition is not met at block 706, the processing logic keeps the existing tag and the existing count.

FIG. 8 illustrates a uniquify example 800 where the tuple sorting pipeline 806 keeps only tuples with unique address tags according to at least one embodiment. As described above, the tuple sorting pipeline 806 may uniquify the sorted tuples. As illustrated in FIG. 8, the tuple sorting pipeline 806 receives six arriving tuples 804. The six tuples are received over time, as indicated by the arrow. The tuple sorting pipeline 806 receives a first tuple with a first address tag and a first count of zero (An,0). The tuple sorting pipeline 806 receives a second tuple with the same first address tag (An) and a second count of one (An,1). As a result, the first tuple is discarded, keeping only the second tuple with the higher count (An,0). The tuple sorting pipeline 806 receives a third tuple with the same first address tag (An) and a third count of six (An,6). The tuple sorting pipeline 806 discards the second tuple, keeping the third tuple with the higher count (An,6). The tuple sorting pipeline 806 receives a fourth tuple with a second address tag and a count of two (Az,2). The tuple sorting pipeline 806 may sort the tuples with the highest count tuple on top (or, alternatively, the directions could be switched). The tuple sorting pipeline 806 receives a fifth tuple with a third address tag and a count of eight (Am,8). The tuple sorting pipeline 806 may sort the tuples with the highest count tuple on top (or, alternatively, the directions could be switched). That is, the third tuple (An,6) and fourth tuples (Az,2) are shifted down in the list. The tuple sorting pipeline 806 receives a sixth tuple with the first address tag and a count of seven (An, 7). The tuple sorting pipeline 806 may discard the third tuple (An,6), keeping the sixth tuple in its place.

FIG. 9 is a flow diagram of a method 900 for sorting multiple copies of access counts targeting different logical groupings of memory locations according to at least one embodiment. The method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 900 is performed by any of the hardware described above with respect to FIG. 1 to FIG. 9A.

Referring to FIG. 9, the method 900 begins with the processing logic receiving an indication of a memory access at the memory controller, the memory access being directed to a memory location (block 902). The processing logic updates and records multiple copies of access counts targeting a logical grouping of memory locations (block 904). The processing logic continuously sorts the multiple copies of access counts and their associated address tags corresponding to the logical grouping of memory locations, keeping only the multiple copies of access counts with unique address tags (block 906). The method 900 may also include other operations as described herein.

FIG. 10 illustrates an output array over time in a register file 1000 according to at least one embodiment. At a first time 1002, the output array has a first snapshot of a sorted access counts. At a second time 1004, the output array has two snapshots of sorted access counts. At a subsequent time 1006, the output array has multiple snapshots of sorted access counts, such as up to a number M (e.g., M=32). The register file 1000 may be accessible by software. That is, the register file 1000 may be queried by other entities, such as software executed by a host, at any time.

The embodiments of access tracking logic described herein may be implemented in a computer system. The computer system may be connected (e.g., networked) to other machines in a local area network (LAN), an intranet, an extranet, and/or the Internet. The computer system may operate in the capacity of a server or a client machine in a client-server network environment, as a peer machine in a peer-to-peer (or distributed) network environment, or as a server or a client machine in a cloud computing infrastructure or environment.

The computer system may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. The computer system may be a single device or a collection of devices that individually or jointly execute a set (or multiple sets) of instructions to perform any one or more of the methodologies discussed herein.

An example computer system may include a processing device, a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage device, which communicate with each other via a bus. The processing device may include a memory controller to access the memory device. The memory controller may include the access tracking logic described herein.

The processing device may represent one or more general-purpose processing devices, such as a microprocessor, a central processing unit, or the like. More particularly, the processing device may be a complex instruction set computing (CISC) microprocessor, a reduced instruction set computing (RISC) microprocessor, a very long instruction word (VLIW) microprocessor, or a processor implementing other instruction sets, or processors implementing a combination of instruction sets. The processing device may also be one or more special-purpose processing devices, such as an application-specific integrated circuit (ASIC), a field programmable gate array (FPGA), a digital signal processor (DSP), a network processor, or the like. The processing device may be configured to execute instructions for performing the operations and steps discussed herein.

The computer system may further include a network interface device to communicate over a network. The computer system also may include a video display unit (e.g., a liquid crystal display (LCD) or a cathode ray tube (CRT)), an alpha-numeric input device (e.g., a keyboard), a cursor control device (e.g., a mouse), a signal generation device (e.g., a speaker), a graphics processing unit, a video processing unit, and an audio processing unit.

The data storage device may include a machine-readable storage medium (also known as a computer-readable storage medium) on which is stored one or more sets of instructions or software embodying any one or more of the methodologies or functions described herein. The instructions may also reside, completely or at least partially, within the main memory and/or within the processing device during execution thereof by the computer system, the main memory, and the processing device also constituting machine-readable storage media.

In one implementation, the instructions include instructions to implement functionality as described herein. While the machine-readable storage medium is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that causes the machine to perform any one or more of the methodologies of the present disclosure. The term “machine-readable storage medium” shall accordingly be taken to include, but not be limited to, solid-state memories, optical media, and magnetic media.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

Typically, such “fragile” data is delivered sequentially from the data source to each of its destinations. The transfer may include transmitting or delivering the data from the source to a single destination and waiting for an acknowledgment. Once the acknowledgment has been received, the source then commences the delivery of data to the next destination. The time required to complete all the transfers may potentially exceed the lifespan of the delivered data if there are many destinations or there is a delay in reception for one or more transfer acknowledgments. This has traditionally been addressed by introducing multiple timeout/retry timers and complicated scheduling logic to ensure timely completion of all the transfers and identify anomalous behavior.

In at least one embodiment, the situation may be improved by either broadcasting the data to all the destinations at once, like a multi-cast transmission in Ethernet. This may decouple the data delivery and acknowledgment without delaying the delivery of data by a previous destination's delivery acknowledgment. These approaches may provide some following benefits, as well as others. Broadcasting the data to all destinations at once may remove any limit to the number of destinations that may be supported. The control logic may be simplified. For example, there may be a single time to track the lifespan of data and a single register to track delivery acknowledgment reception. In one embodiment, an incomplete delivery is simply indicated by the register not being fully populated by l's (or 0's if the convention is reversed) at the end of the data timeout period.

What is claimed is:

1. A memory controller comprising:
a processing pipeline comprising a first processing stage to update and record a first number of access counts targeting a logical grouping of memory locations and a second processing stage to continuously sort the first number of access counts and their associated address tags corresponding to the logical grouping of memory locations, keeping only the access counts with unique address tags.

2. The memory controller of claim 1, wherein the first processing stage comprises a counting bloom filter (CBF) to receive an address tag for each memory access, pre-filter the first number of access counts, and output a tuple for each memory access, each tuple comprising a count value and the associated address tag corresponding to the respective memory access.

3. The memory controller of claim 1, wherein the first processing stage is to update and record the multiple copies of access counts over a configurable time interval.

4. The memory controller of claim 1, wherein the logical grouping of memory locations is a page, and wherein the associated address tags are page tags.

5. The memory controller of claim 4, wherein a size page of the page is approximately 2 mebibyte (2 MiB) or less.

6. The memory controller of claim 1, wherein:
the first processing stage comprises a counting bloom filter (CBF) to pre-filter the first number of access counts over a configurable time interval, the CBF to output a tuple on each memory access, the tuple comprising a count value and an address tag; and
the second processing stage comprises a tuple sorting pipeline to receive the tuples from the CBF and continuously sort the first number of tuples over the configurable time interval, the tuple sorting pipeline to output a snapshot of sorted tuples at the end of the configurable time interval.

7. The memory controller of claim 6, wherein the tuple sorting pipeline is to store the snapshot of sorted tuples in an output array having a second number of snapshots of sorted tuples.

8. The memory controller of claim 7, wherein the output array is stored in a register file accessible by software.

9. The memory controller of claim 1, wherein the processing pipeline is reset responsive to receiving a reset signal.

10. The memory controller of claim 1, wherein the second processing stage comprises inline sorting logic to provide an access count array with a number of sorted tuples during a configurable time interval, each tuple of the number of tuples comprises a count value and an address tag.

11. An integrated circuit comprising:
a first interface coupled to one or more host devices;
a second interface coupled to one or more memory devices;
a memory controller operatively coupled to the first interface and the second interface; and
access tracking logic coupled to or part of the memory controller, wherein the access tracking logic is to:
receive an indication of a memory access at the memory controller, the memory access being directed to a memory location;
update and record multiple copies of access counts targeting a logical grouping of memory locations;
continuously sort the multiple copies of access counts and their associated address tags corresponding to the logical grouping of memory locations, keeping only the multiple copies of access counts with unique address tags.

12. The integrated circuit of claim 11, wherein the access tracking logic comprises:
a counting bloom filter (CBF) to receive the indication of the memory access and output a tuple comprising a count value and an address tag corresponding to the memory access;
a tuple sorting pipeline to receive the tuple from the CBF and continuously sort a first number of tuples over a configurable time interval, the tuple sorting pipeline to output a snapshot of sorted tuples at the end of the configurable time interval.

13. The integrated circuit of claim 11, wherein the logical grouping of memory locations is a page, and wherein the associated address tags are page tags.

14. The integrated circuit of claim 11, wherein the tuple sorting pipeline is to store the snapshot of sorted tuples in an output array having a second number of snapshots of sorted tuples.

15. The integrated circuit of claim 14, wherein the output array is stored in a register file accessible by software.

16. A system comprising:
a memory device; and
a memory controller coupled to the memory device via a channel, wherein the memory controller comprises a register file to store an output array of access counts corresponding to a set of logical grouping of memory locations, wherein the memory controller comprises:
a processing pipeline comprising a first processing stage to update and record a first number of access counts targeting a logical grouping of memory locations and a second processing stage to continuously sort the first number of access counts and their associated address tags corresponding to the logical grouping of memory locations, keeping only the access counts with unique address tags.

17. The system of claim 16, wherein the first processing stage comprises a counting bloom filter (CBF) to receive an address tag for each memory access, pre-filter the first number of access counts, and output a tuple for each memory access, each tuple comprising a count value and the associated address tag corresponding to the respective memory access.

18. The system of claim 16, wherein the first processing stage is to update and record the multiple copies of access counts over a configurable time interval, wherein the logical grouping of memory locations is a page, and wherein the associated address tags are page tags.

19. The system of claim 16, wherein:
the first processing stage comprises a counting bloom filter (CBF) to pre-filter the first number of access counts over a configurable time interval, the CBF to output a tuple on each memory access, the tuple comprising a count value and an address tag; and
the second processing stage comprises a tuple sorting pipeline to receive the tuples from the CBF and continuously sort the first number of tuples over the configurable time interval, the tuple sorting pipeline to output a snapshot of sorted tuples at the end of the configurable time interval.

20. The system of claim 16, wherein the memory device is a dynamic random-access memory (DRAM) device.
